(19) United States
(12) Patent Application Publication
(10) Pub. No.: US 2006/0080350 A1
(43) Pub. Date: Apr. 13, 2006

(54) Allocation of file storage based on pattern recognition

(76) Inventor: Timothy Mark, Goffstown, NH (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/966,169

(22) Filed: Oct. 13, 2004

(51) Int. Cl. G06F 17/30

(52) U.S. Cl. 707/102

(57) ABSTRACT

In one embodiment, a method and system for allocating storage space in a storage medium for storing data in a file from at least one application running in an information system is provided. The method and system includes monitoring at least one characteristic of a plurality of data storage operations when data is stored on the storage medium for the file by the at least one application, identifying a storage pattern from the monitored at least one characteristic of the plurality of data storage operations, determining an amount of storage space to be used for additional data for the file as needed based on the identified storage pattern, and allocating the amount of storage space to the file on a storage medium for the additional data.

### BACKGROUND

Typical information systems, such as computer systems, are controlled by an operating system that runs on a processor. The operating system controls, among other things, the storage of data from application programs on storage devices, e.g., magnetic disk drives, optical drives, tape drives, FLASH memory, or other appropriate storage media. This data storage operation is typically performed by a file system function of the operating system.

Ideally, a file would be stored by the file system function in a single, contiguous location in the storage device. Unfortunately, this is not practical for most, if not all, information systems. Rather, data files are typically stored in non-contiguous fragments spread across the storage media. This is the undesirable side effect of a large number of files sharing the same storage device. Further, the file system function typically allocates storage a little at a time rather than all up front due the bursty manner in which application programs typically generate data.

Thus, a file is typically stored as a plurality of fragments at various locations on the storage medium. When a file is created, the file system function allocates an initial storage capacity in the storage device to the file. As the allocated space is used, the file system function allocates more space for the file. The quantity of storage space reserved for the file in each allocation is typically based on the size of the file at the time the allocation is made or on a very basic recent history of the write pattern to the file. Unfortunately, this process can divide a single file into a large number of fragments scattered over the storage device. File fragmentation can cause problems in retrieving data from the file. For example, a data request may require data to be retrieved from a number of physically far-flung locations. This makes access to the data in the file take more time, slowing down the application. In addition, it requires more file system memory to represent the many pieces of the fragmented file. And finally, it takes more processor time to scan or otherwise manipulate the in-memory representation of the fragmented file.

### SUMMARY

Embodiments of the present invention use pattern recognition for allocating storage for a file in a storage media. In one embodiment, a method for allocating storage space in a storage medium for storing data in a file from at least one application running in an information system is provided. The method includes monitoring at least one characteristic of a plurality of data storage operations when data is stored on the storage medium for the file by the at least one application, identifying a storage pattern from the monitored at least one characteristic of the plurality of data storage operations, determining an amount of storage space to be used for additional data for the file as needed based on the identified storage pattern, and allocating the amount of storage space to the file on a storage medium for the additional data.

In another embodiment, an information system is provided. The system includes a processor, a storage medium coupled to the processor, and at least one application program running on the processor, wherein the at least one application program stores data in at least one file on the storage medium. The system also includes a pattern recognition function, running on the processor, and adapted to identify patterns of the application program in storing data in the file and a file system function, running on the processor, the file system function allocating storage space on the storage medium for the file of the application based on input from the pattern recognition function.

In another embodiment, a machine readable medium having instructions stored thereon for performing a method for allocating storage space in a storage medium for storing data in a file from at least one application running in an information system is provided. The method includes recording information on data storage operations when data is stored on the storage medium for the file by the at least one application, identifying a storage pattern from the monitored at least one characteristic of the plurality of data storage operations, determining an amount of storage space to be used for additional data for the file based on the identified storage pattern, and allocating the determined amount of storage space to the file on the storage medium for the additional data as needed.

### BRIEF DESCRIPTION OF THE DRAWINGS

FIG. 1 is a block diagram of one embodiment of an information system that uses pattern recognition in allocating storage for a file in a storage media.

FIG. 2 is a schematic representation of an embodiment of a storage device that illustrates data fragments for a data file generated with a conventional file system function.

FIG. 3 is a schematic representation of an embodiment of a storage device that illustrates allocation of storage for a file in a storage device using pattern recognition.

FIG. 4 is a flow chart of an embodiment of a process for allocating storage for a file using pattern recognition.

FIG. 5 is a flow chart of an embodiment of a process for matching a pattern in data storage operations for a file in an information system.

FIG. 6 is a flow chart of another embodiment of a process for allocating storage capacity using pattern recognition.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Embodiments of the present invention use pattern recognition to allocate storage for a file in a storage medium so as to reduce the amount of fragmentation of data in files stored on the storage medium. For purposes of this specification, the term “pattern recognition” means the ability to abstract and integrate certain elements of a stimulus over time into an organized scheme to allow identification of a later stimulus. As data is stored in a file, embodiments of the present invention apply pattern recognition to previous data storage operations to determine the amount of storage space to allocate for the current data storage operation and future data storage operations for the file.

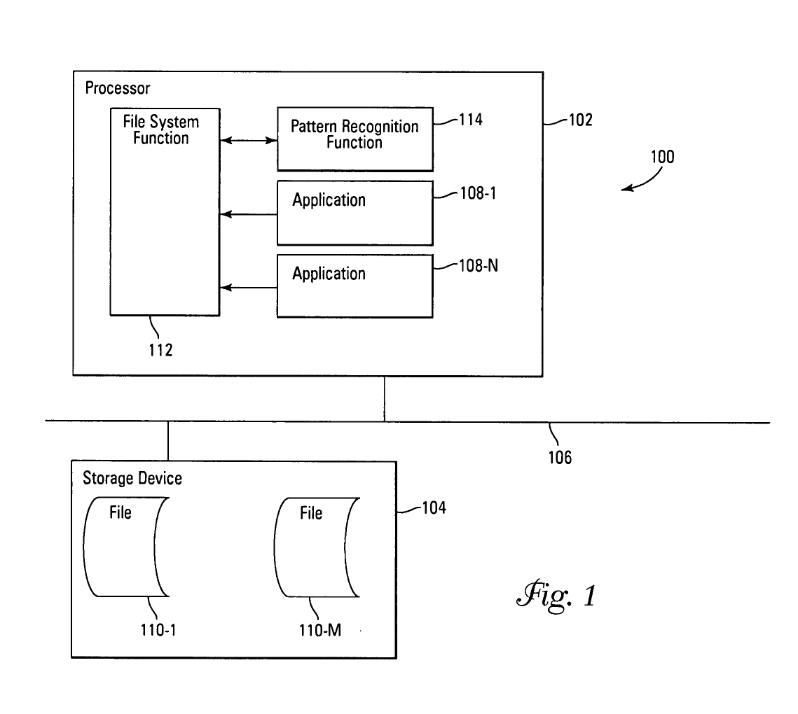

FIG. 1 is a block diagram of one embodiment of an information system, indicated generally at 100, that uses pattern recognition in allocating storage capacity in a storage device 104. In one embodiment, information system 100 comprises a computer system. In other embodiments, information system 100 comprises any other appropriate electronic system that stores data in a storage medium. System 100 includes processor 102 that is coupled to storage device 104 over a bus 106. In one embodiment, storage device 104 comprises a magnetic disk drive. In other embodiments, storage device 104 comprises an optical device, a FLASH memory or other appropriate data storage device.

Processor 102 runs a number of functions for system 100. File system function 112 runs on processor 102. Among other functions, file system function 112 controls, in one embodiment, the allocation of storage space in storage device 104 for storage of data in files 110-1 to 110-M. In one embodiment, file system function 112 is part of an operating system running on processor 102. Additionally, processor 102 runs a number of applications 108-1 to 108-N. In one embodiment, applications 108-1 to 108-N comprise any appropriate software program that runs on a computer system.

Processor 102 also runs a pattern recognition function 114. Pattern recognition function 114 communicates with file system function 112. Pattern recognition function 114 processes information on data stored in files 110-1 to 110-M in storage device 104. Pattern recognition function 114 identifies patterns in the storage of data in the files 110-1 to 110-M. In one embodiment, pattern recognition function 114 identifies a pattern based on at least three data storage operations. When a pattern is identified, this information is provided to file system function 112. In one embodiment, this information includes a factor that indicates the strength of the recognized pattern. Based on the information from the pattern recognition function 114, file system function 112 allocates storage capacity in storage device 104 for a particular file 110-1 to 110-M. In one embodiment, each file is associated with a particular application 108-1 to 108-N. In other embodiments, a particular file 110-1 to 110-M is associated with more than one of applications 108-1 to 108-N. In one embodiment, when more than one application shares the same data file, file system function 112 separately allocates storage capacity for the file in storage device 104 for storage of data in the file by each application based on the pattern of storage operations from each application.

In operation, file system function 112 controls the allocation of storage capacity in storage device 104 based on information from pattern recognition function 114. The following example illustrates the manner in which file system function 112 allocates storage capacity for data from application 108-1 in file 110-1 on storage device 104 using pattern recognition. Application 108-1 generates data to be stored in storage device 104. File system function 112 allocates storage capacity in storage device 104 for file 110-1. Application 108-1 stores data in the allocated space until it is full. Pattern recognition function 114 receives information on each storage of data and determines if there is a pattern in the storage operations for application 108-1. In one embodiment, the pattern recognition function 114 maintains the information on the storage operations in a history cache as discussed in more detail below. In one embodiment, a pattern is identified based on at least three data storage operations. Pattern recognition function 114 reports the pattern to file system function 112 when requested. When more storage capacity is needed for file 110-1 of application 108-1, file system function 112 allocates more storage capacity in storage device 104 based on the pattern identified by pattern recognition function 114. Further, in one embodiment, the quantity of storage space allocated by file system function 112 depends, in part, on the strength of the recognized pattern. For example, in one embodiment, the strength factor is a scalar quantity, S. The quantity of storage capacity allocated to the file 110-1 is determined based on S times a nominal amount of storage space identified in the pattern, e.g., S*2 kilobytes.

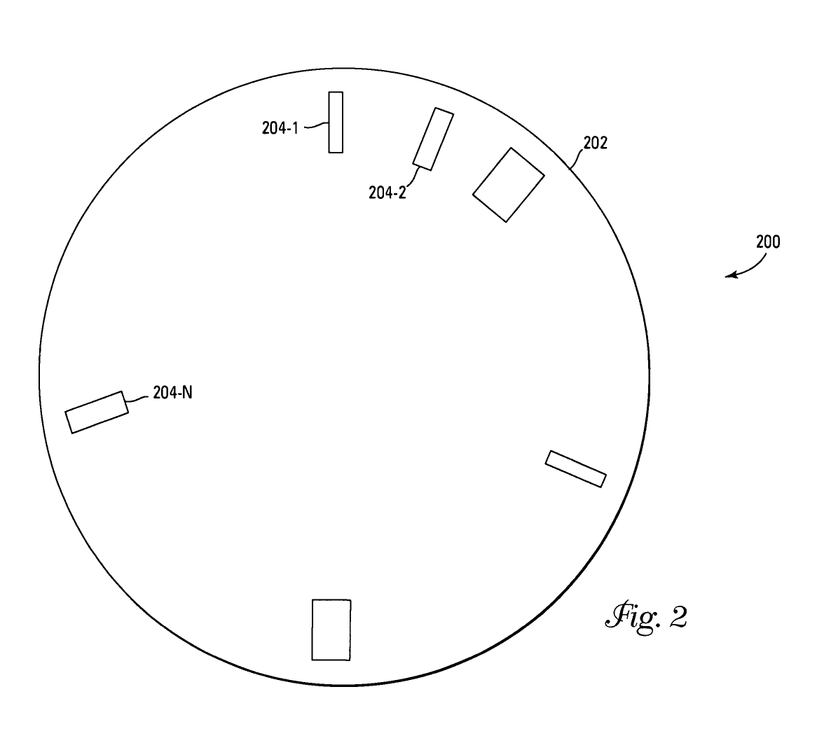

FIG. 2 is a schematic representation of a storage device 200 that illustrates data fragments for a data file generated with a conventional file system function. A conventional file system function stores data on storage medium 202, e.g., a magnetic disk, of storage device 200. In this example, the file system function initially allocates a small portion of the storage capacity of storage medium 202, indicated at 204-1, to a file for use by one or more applications. As the one or more applications generate data, the data is stored in storage location 204-1 until it is full. As other data is generated by the application program, the file system function allocates other storage locations, e.g., 204-2 to 204-N. Conventionally, the file system function decides on the quantity of storage capacity to allocate to the file based on the total size of the file at the time of the allocation. When the size of the file exceeds a specific threshold, the file system function typically allocates a bigger storage area, typically capping the allocation request at some defined threshold. This simplistic approach unfortunately often leads to a significant amount of fragmentation of the file. Therefore, retrieval of data from the file is complicated and slowed by requiring the storage medium 202 to bounce around between various locations to retrieve what could have been confined to a smaller number of larger fragments.

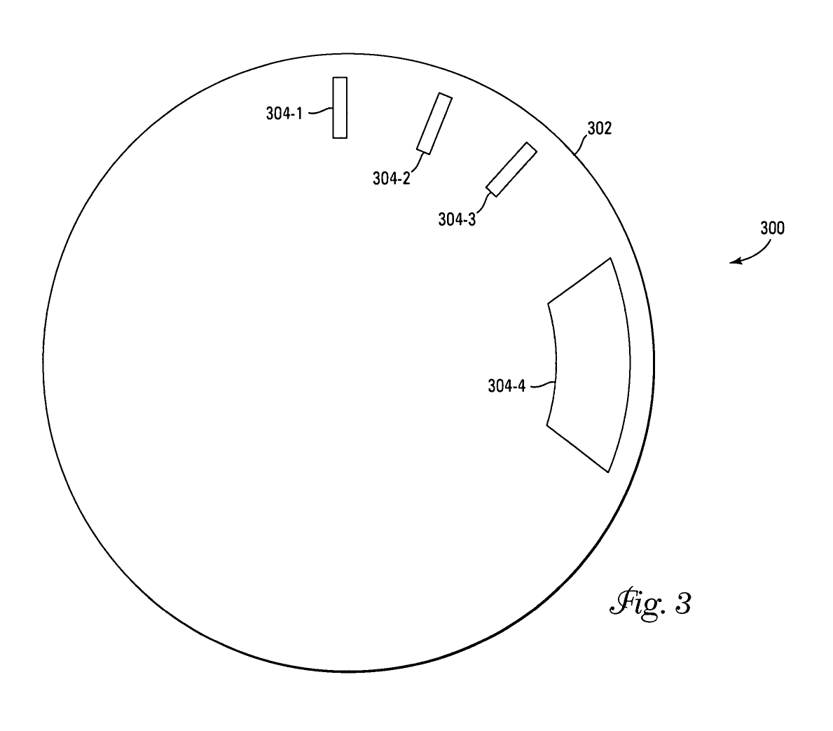

FIG. 3 is a schematic representation of a storage device 300 that illustrates allocation of storage capacity in a storage medium 302 using pattern recognition. The example shown here in FIG. 3 illustrates, for example, the manner in which pattern recognition function 114 of FIG. 1 enables file system function 112 to reduce the amount of fragmentation in files stored in storage device 104. In this example, the file system function initially allocates storage capacity in storage medium 302 at storage location 304-1. When storage location 304-1 is full, file system function 112 tries to determine if there is a pattern in the writing of data to storage device 302. The file system function continues to allocate storage capacity using conventional approaches until a pattern is recognized. As can be seen in this example, after storage locations 304-1 to 304-3 have been used, the file system function identified a pattern in the storage operations for storage device 300 and allocated a larger storage location 304-4 for storing data for the file. Advantageously, by identifying a pattern in storing data to the file, the file system function is able to intelligently allocate storage space to files so as to reduce the fragmentation of a file and to avoid wasting valuable storage capacity on the storage medium 302.

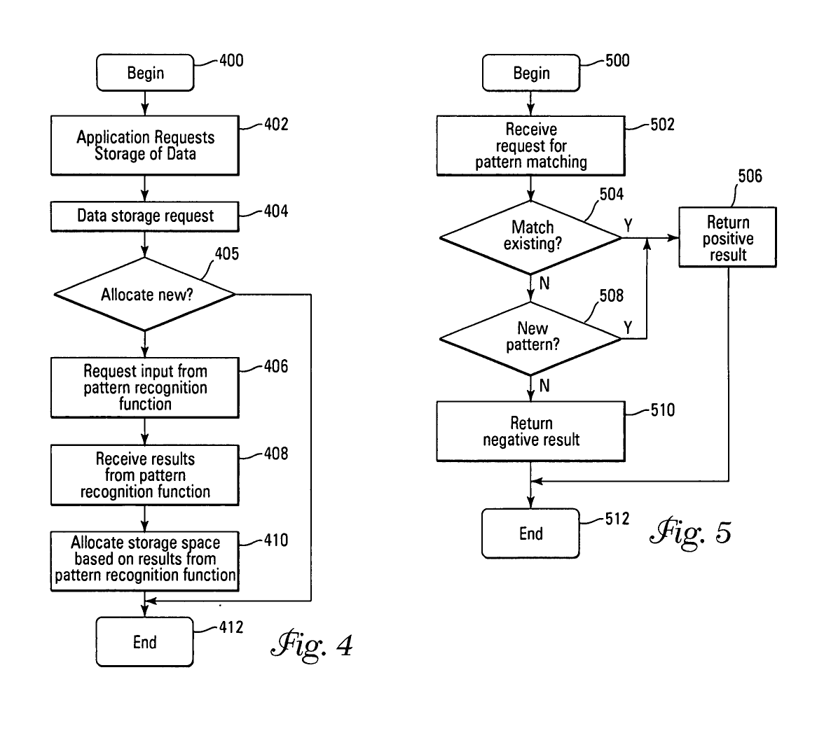

FIG. 4 is a flow chart of an embodiment of a process for allocating storage for a file using pattern recognition. The process begins at block 400. At block 402, the process receives a request from an application to store data in a file on a storage medium under the direction of a file system function. At block 404, the process requests a data storage operation at the storage device. The process further passes the request to the pattern recognition function so that the pattern recognition function can build a history of the data storage operations. In one embodiment, a history cache is created and maintained by the pattern recognition function. The history cache tracks requests to store data. In one embodiment, the history cache also stores the offset into the file for completed storage operations. In other embodiments, the history cache stores the quantity of data stored in the storage operation. In further embodiments, the history cache stores the information on the storage operations on a per application basis for a number of applications that use the same file. In yet further embodiments, the information is stored in a history cache which records information on each write of data to the file. In one embodiment, a pattern in the history cache is identified based on at least three data storage operations.

The process allocates additional space for the file when necessary. At block 405, the process determines whether additional storage space is needed, e.g., to satisfy the data storage request. If no additional storage space is needed, the process for allocating storage space ends at block 412. If, however, the process determines at block 405 that additional storage space is needed for the file, the process allocates additional storage space.

The process uses pattern recognition to determine the amount of storage space to allocate to the file. At block 406, the process requests input from the pattern recognition function. In one embodiment, the process requests the pattern recognition function to analyze data in a history cache to determine if a pattern of storage operations has been identified for the storage of data by the application. As described above, the history cache is compiled based on requests to store data and on data storage operations.

Further, in one embodiment, the pattern recognition function also identifies the strength of the identified pattern. In one embodiment, the strength of a pattern increases with the number of storage operations that match the pattern.

At block 408, the process receives the results of the pattern recognition function. In one embodiment, this includes an indication of a pattern identified in the storage operations. In another embodiment, this also includes a value that indicates the strength of the pattern identified by the pattern recognition function. At block 410, the process allocates storage space based on the results from the pattern recognition function. The process ends at block 412.

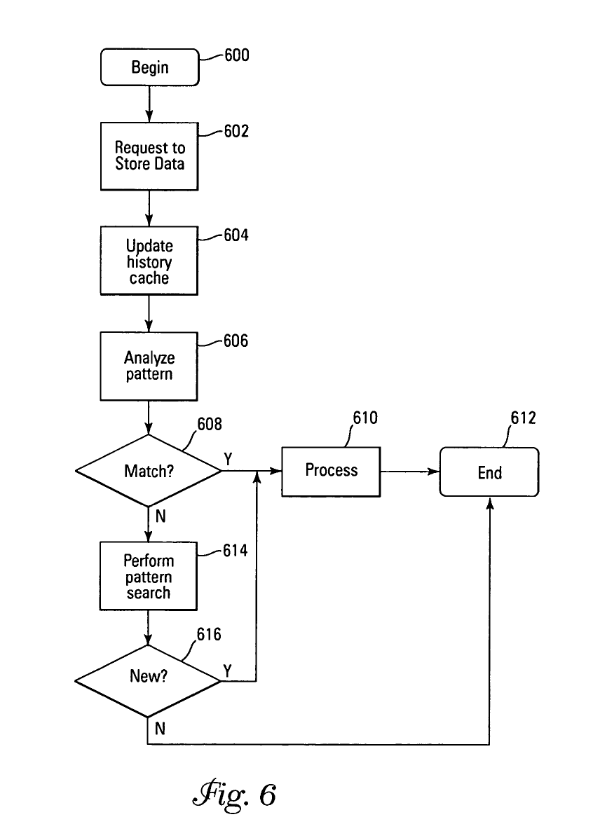

FIG. 5 is a flow chart of an embodiment of a process for matching a pattern in data storage operations for a file in an information system. The process begins at block 500. At block 502, the process receives a request for identifying a pattern in a plurality of data storage operations. At block 504, the process analyzes a history of data storage operations and determines if the data storage operations match a known pattern. If a pattern is matched, the process returns a result at block 506. In one embodiment, the result includes an indication of the matched pattern. In other embodiments, the result also includes an indication of the strength of the pattern. The process ends at block 512.

If at block 504, the process does not find a match, the process determines if a new pattern has emerged in the data storage operations at block 508. In one embodiment, the process identifies a pattern based on at least three data storage operations. If a new pattern has emerged, the process proceeds to block 506 and returns the result of the pattern matching. The process further updates the known patterns with the newly identified pattern. The process ends at block 512.

If at block 508 a new pattern is not identified, the process returns a negative result at block 510. The negative result indicates that a pattern has not been identified in the data storage operations. The process ends at block 512.

FIG. 6 is a flow chart of another embodiment of a process for allocating storage capacity using pattern recognition. The process begins at block 600. At block 602, the process requests storage of data in a data storage device, e.g., a magnetic disk drive, an optical disk drive, a FLASH memory or the like. At block 604, the process updates a history cache with information on the data storage operation of block 602. In one embodiment, the history cache stores information on each data storage operation when data is written to a file in the storage device. In one embodiment, the process updates the history cache with an indication of the file, the application writing to the file, the quantity of data, the offset into the file, and/or any other appropriate information on the data storage operation.

At block 606, the process analyzes the history cache for a matched pattern. At block 608, the process determines whether the data storage operations for data written to the file by the application matched a pattern at block 606. If the data storage operations matched a pattern, the process proceeds to block 610 and processes the match by allocating storage capacity based on the matched pattern when needed. Further, in one embodiment, the process determines a strength value for the pattern. The process ends at block 612.

If a pattern was not matched at block 606, the process proceeds to block 614 to search for a new pattern in the history cache. At block 616, the process determines whether a new pattern has been identified. If so, the process proceeds to block 610 and adds the new pattern. In one embodiment, the process also adds a value that indicates the strength of the new pattern. The process ends at block 612. If the process does not identify a new pattern a block 616, the process ends at block 612.

Those skilled in the art will recognize that the techniques and methods described here are implemented, in some embodiment, by programming a programmable processor with appropriate instructions to implement the functionality described here. In such embodiments, such program instructions are stored in a suitable memory device (for example, read-only memory and/or random-access memory) from which the program instructions are retrieved during execution. Also, suitable data structures are stored in memory in such embodiments.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A method for allocating storage space in a storage medium by storing data in a file from at least one application running in an information system, the method comprising:
monitoring at least one characteristic of a plurality of data storage operations when data is stored on the storage medium for the file by the at least one application;
identifying a storage pattern from the monitored at least one characteristic of the plurality of data storage operations;
determining an amount of storage space to be used for additional data for the file as needed based on the identified storage pattern; and
allocating the amount of storage space to the file on the storage medium for the additional data.

2. The method of claim 1, wherein monitoring the at least one characteristic comprises monitoring at least one of a file offset value for storage of data, and a quantity of data stored.

3. The method of claim 1, wherein monitoring the at least one characteristic comprises creating a cache that holds data on a size and an offset of each write of data to the file.

4. The method of claim 1, wherein identifying the storage pattern comprises gathering data on at least three of the data storage operations.

5. The method of claim 1, wherein identifying the storage pattern comprises determining a strength value for the storage pattern.

6. The method of claim 5, wherein determining an amount of storage comprises determining an amount of storage based on the strength of the storage pattern.

7. A method for storing data in a file in a computer system, the method comprising:
monitoring at least one characteristic of a data storage operation for the file;
identifying a pattern from the monitored data storage operations;
determining a strength value for the pattern; and
allocating space to the file to store data based on the strength value of the identified pattern as needed.

8. The method of claim 7, wherein monitoring at least one characteristic of a data storage operation comprises monitoring at least one of file offset and quantity of data.

9. The method of claim 7, wherein monitoring the at least one characteristic of a data storage operation comprises storing information in cache based on each of the data storage operation.

10. The method of claim 7, wherein allocating space to the file comprises allocating space to the file in proportion to the strength value of the pattern.

11. The method of claim7, wherein determining the strength value for the pattern comprises increasing the strength value for the pattern with each of the storage operations that matches the observed pattern.

12. A method for allocating storage space on a storage medium for storing data of a file for at least one application in an information system, the method comprising:
storing data in the file from the at least one application;
storing information on the data storage operation;
requesting operation of a pattern recognition function on the stored information;
receiving a response from the pattern recognition function; and
based on the response from the pattern recognition function, allocating additional storage for the file as needed.

13. The method of claim 12, wherein storing data in the file comprises storing data in the file from one of at least two applications that share the same file.

14. The method of claim 13, wherein storing information on the data storage operation comprises separately tracking data storage operations for each of the at least two applications that share the same file.

15. The method of claim 12, wherein storing information on the data storage operation comprises storing at least one of a file offset and a size of data stored in the file.

16. The method of claim 12, wherein receiving a response from the pattern recognition software comprises receiving an indication of a storage pattern for the data stored in the file by the at least one application and an indication of the strength of the storage pattern.

17. The method of claim 12, wherein allocating additional storage comprises allocating a select amount of storage based on a recognized storage pattern.

18. The method of claim 17, wherein allocating additional storage further comprises selecting the amount of storage based on a strength factor associated with a recognized storage pattern.

19. An information system, comprising:
a processor;
a storage medium coupled to the processor;
at least one application program running on the processor, wherein the at least one application program stores data in at least one file on the storage medium;
a pattern recognition function, running on the processor, and adapted to identify patterns of the application program in storing data in the file; and
a file system function, running on the processor, the file system function allocating storage space on the storage medium for the file of the application based on input from the pattern recognition function.

20. The information system of claim 19, wherein the file system function stores information in a history cache each time data is written to the file.

21. The information system of claim 19, wherein the storage medium comprises at least one of a magnetic disk, an optical disk, and a flash memory.

22. The information system of claim 19, wherein the pattern recognition function identifies a strength value for the recognized pattern.

23. The information system of claim 19, wherein the at least one application comprises a plurality of applications wherein at least two of the application programs write data to the same one of the at least one file.

24. A machine readable medium having instructions stored thereon for performing a method for allocating storage space in a storage medium for storing data in a file from at least one application running in an information system, the method comprising:
recording information on data storage operations when data is stored on the storage medium for the file by the at least one application;
identifying a storage pattern from the monitored at least one characteristic of the plurality of data storage operations;
determining an amount of storage space to be used for additional data for the file based on the identified storage pattern; and
allocating the determined amount of storage space to the file on the storage medium for the additional data as needed.

25. The medium of claim 24, wherein the recording information comprises monitoring at least one of file offset value for storage of data, and size of data stored.

26. The medium of claim 24, wherein the recording information comprises creating a cache that holds data on a size and an offset of each write of data to the file.

27. The medium of claim 24, wherein the identifying the storage pattern comprises processing information on at least three data storage operations.

28. The medium of claim 24, wherein the identifying a storage pattern comprises determining a strength value for the storage pattern.

29. The medium of claim 28, wherein the determining an amount of storage comprises determining an amount of storage based on the strength of the pattern.

30. A machine readable medium having instructions stored thereon for performing a method for allocating storage space on a storage medium for storing data of a file for at least one application in an information system, the method comprising:
storing data in the file from the at least one application;
recording information on the data storage operation;
performing pattern recognition on the recorded information to identify a storage pattern; and
allocating additional storage for the file based on the storage pattern.

31. The medium of claim 30, wherein storing data in the file comprises storing data in the file from one of at least two applications that share the same file.

32. The medium of claim 31, wherein recording information on the data storage operation comprises separately tracking data storage operations for each of the at least two applications that share the same file.

33. The medium of claim 30, wherein recording information on the data storage operation comprises storing at least one of a file offset and a size of data stored in the file.

34. The medium of claim 30, wherein performing pattern recognition comprises generating an indication of a storage pattern for the data stored in the file by the at least one application and an indication of the strength of the storage pattern.

35. The medium of claim 30, wherein allocating additional storage comprises allocating a select amount of storage based on a recognized storage pattern.

36. The medium of claim 35, wherein allocating additional storage further comprises selecting the amount of storage based on a strength factor associated with a recognized storage pattern.

37. An information system, comprising:
a processor;
a storage medium coupled to the processor;
at least one application program running on the processor, wherein the at least one application program stores data in at least one file on the storage medium;
means for recognizing patterns of the application program in storing data in the file; and
means for allocating storage space on the storage medium for the file of the application based on input from the means for recognizing patterns.

38. The information system of claim 37, and further comprising means for storing information in a history cache each time data is written to the file.

39. The information system of claim 37, wherein the means for recognizing patterns comprises means for identifying a strength value for the recognized pattern.
